(19) United States
(12) Patent Application Publication
(10) Pub. No.: US 2003/0070556 A1
(43) Pub. Date: Apr. 17, 2003

(54) VERTICAL TOASTER

(76) Inventor: Lee Ming-Hsiu, Taichung City (TW)

Correspondence Address: BRUCE H. TROXELL, 5205 LEESBURG PIKE, SUITE 1404, FALLS CHURCH, VA, 22041, US

(21) Appl. No.: 10/234,521

(22) Filed: Sep. 5, 2002

(30) Foreign Application Priority Data
Oct. 16, 2001 (TW) 902017754

(51) Int. Cl. A47J 37/08

(52) U.S. Cl. 99/327; 99/385; 99/389

(57) ABSTRACT

Vertical toaster including a housing having a front open face, at least one pair of rails parallelly disposed in the housing, several heaters arranged in the housing and spaced from the rails by a certain distance and at least one grill bridged between the rails and reciprocally movable between a first and a second positions. A predetermined section of the rail gradually inward and upward extends. At least one locating member is disposed in the housing corresponding to the grill, whereby a slice of toast can be horizontally placed on the grip to be heated by the heater. The locating member serves to fix the grill in the second position. After the toast is toasted, the locating member releases the grill and makes the grill slide to the first position for a user to take out the toast.

### BACKGROUND OF THE INVENTION

The present invention is related to a toaster, and more particularly to a vertical toaster including several grills. Multiple slices of toasts can be horizontally placed on the grills and toasted at the same time. After toasted, the grills automatically slide out for a user to conveniently take out the toasts.

A conventional small-size toaster has a housing. The upper end of the housing is formed with two slots. Three sets of nickel chrome wires are arranged in the housing at intervals. A pair of supports are disposed in the housing between the nickel chrome wires. The supports are up and down movably arranged under the slots. A timer and a temperature controller are disposed on outer side of the housing.

In use of the toaster, two slices of toasts are vertically passed through the slots and placed onto the supports. Then, via a handle, the toasts are retracted into the toaster to be heated by the nickel chrome wires at a set temperature for a set heating time. After heated, the supports are slightly bounded out for a user to take out the toasts. Then the user can paint fruit jam or butter on the toasts.

In a diner, it is necessary to provide different thickness of slices of toasts for the customers. Under such circumstance, it is necessary to often adjust the heating time. In order to shorten the waiting time, the diner owner must prepare many toasters to toast the slices of toasts at one time. These toasters will occupy much room of the diner.

With respect to the current thick slice of toast, some diner runners often first paint the jam or butter onto the toast and then heat the toast with the jam or butter. In the case that the above toaster is used to toast such slice of toast, the jam or butter will drip into the toaster and be hard to clean up. Also, the jam or butter cannot infiltrate into the toast. Therefore, in order to toast the slice of toast in a horizontal state, such diner owners try to toast the slice of toast with a domestic small-size baker. Such small-size baker has larger volume and slower heating speed. Moreover, it is relatively inconvenient to place the slice of toast into such baker and take out the slice of toast therefrom.

### SUMMARY OF THE INVENTION

It is therefore a primary object of the present invention to provide a vertical toaster having small volume. Multiple slices of toasts can be horizontally placed on the grills of the toaster and toasted at the same time.

It is a further object of the present invention to provide the above vertical toaster in which multiple slices of toasts can be layer by layer horizontally placed on the grills and respectively toasted. Also, it is convenient for a user to take out the toasts.

According to the above objects, the vertical toaster includes: a housing having a front open face; at least one pair of rails disposed in the housing, the rails being fixed on inner faces of left and right walls of the housing in parallel to each other, the rails inward extending from the front open face of the housing by a certain length; several heaters arranged in the housing and spaced from the rails by a certain distance; and at least one grill having a predetermined shape and bridged between the rails, the grill being reciprocally movable between a first and a second positions along a lengthwise direction. The vertical toaster is characterized in that a predetermined section of the rail gradually inward and upward extends. At least one locating member is disposed in the housing corresponding to inner side of the grill distal from the front open face of the housing, whereby a slice of toast can be horizontally placed on the grip to be heated by the heater. The locating member serves to fix the grill in the second position. After the toast is toasted, the locating member releases the grill and makes the grill slide to the first position for a user to take out the toast.

The present invention can be best understood through the following description and accompanying drawings wherein:

### BRIEF DESCRIPTION OF THE DRAWINGS

FIG. 1 is a perspective view of a first embodiment of the vertical toaster of the present invention;

FIG. 2 is a sectional view of the first embodiment of the vertical toaster of the present invention;

FIG. 3 is a sectional view of a second embodiment of the vertical toaster of the present invention; and

FIG. 4 is a sectional view of a third embodiment of the vertical toaster of the present invention.

### DETAILED DESCRIPTION OF THE PREFERRED EMBODIMENTS

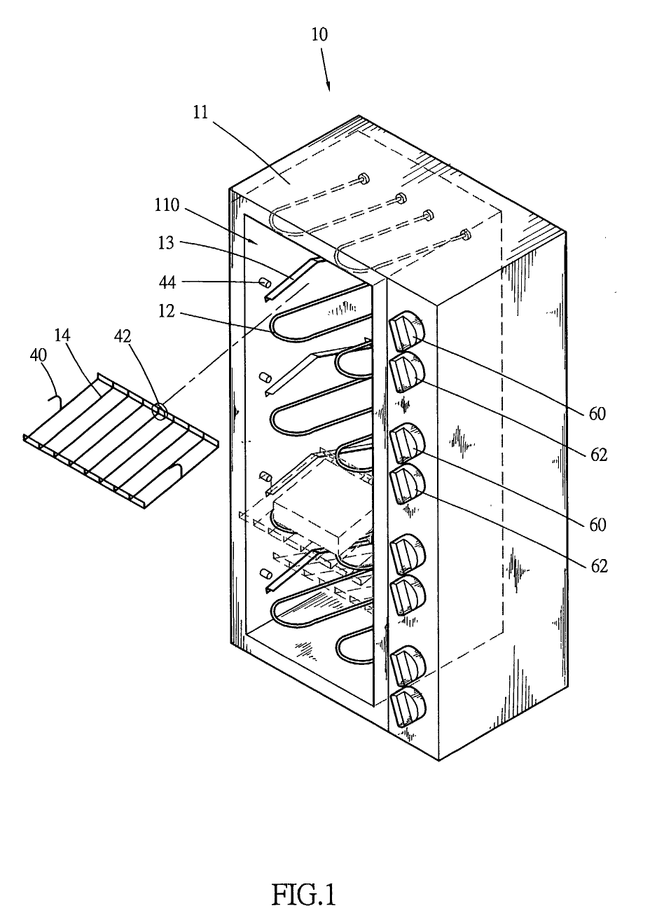

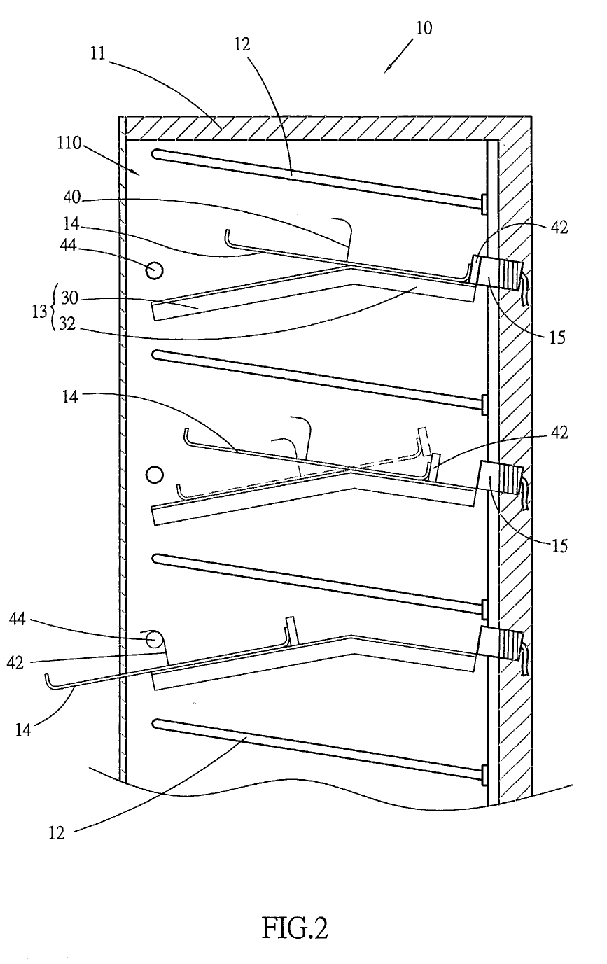

Please refer to FIGS. 1 and 2. The vertical toaster 10 of the present invention includes a housing 11, five sets of heaters 12 sequentially arranged in the housing 11 from upper side to lower side, four pairs of rails 13 positioned between the heaters 12, four grills 14 disposed on the rails 13 and four locating members 15 corresponding to inner sides of the grills 14.

The housing 11 is substantially rectangular and has a front open end 110.

Each set of heater 12 includes two substantially U-shaped heating tubes. The rear ends of the heating tubes are fixed inside the housing 11. The two heating tubes of each set of heater 12 substantially extend on the same plane. Accordingly, the five sets of heaters 12 together form five layers of plane heating areas.

The rails 13 are fixed on inner faces of lateral walls of the housing 11 pair by pair. The rails 13 inward extend from the open end 110 by a certain length. Also, the rails 13 extend toward each other by a certain width. Along the extending direction, each rail 13 has a first extending section 30 inward and upward extending from the open end 110 and a second extending section 32 turning from the rear end of the first extending section 30 to inward and downward extend. The first and second extending sections 30, 32 contain a certain angle. The extending direction of the second extending section 32 is parallel to the plane heating area of the heater 12. The length of the second extending section 32 is slightly shorter than the length of the first extending section 30.

The grill 14 is made of iron wires and has a certain area for horizontally placing a slice of toast thereon. Each lateral side of the grill 14 has an upward projecting hook-like first stop section 40 near the middle of the lateral side. A magnet 42 is fixed on rear side of the grill 14. When assembled, the grills 14 are respectively bridged between corresponding pairs of rails 13. The grills 14 are reciprocally slidable between a first and a second positions respectively corresponding to the first and second extending sections 30, 32. In this embodiment, the grills 14 are horizontally placed on the rails 13. However, for enhancing the sliding effect, several rollers (not shown) can be arranged on the grills 14.

The locating members 15 are disposed on inner side of the housing 11 corresponding to the magnets 42 of the backsides of the grills 14. Generally, the locating members 15 are iron cores which are able to generate induced current and create magnetism.

The heaters 12 and the locating members 15 are respectively connected to a controlling circuit (not shown) via some wires. The controlling circuit is further connected to the four sets of timers 60 and temperature regulators 62 arranged on lateral sides of front face of the housing 11. The controlling circuit serves to control the heating time and temperature of the respective sets of heaters 12 and turn on/off the locating members 15.

In use, a grill 14 is first positioned on the first extending section 30 of the rail 13 near the open end 110 of the housing. A user can horizontally place a toast already painted with jam or butter onto the grill. Then the grill 14 is pushed inward to the second extending section 32 of the rail 13 with the magnet 42 attracting a corresponding locating member 15. Then, via a corresponding timer 60 and a corresponding temperature regulator 62, two sets of heaters 12 on upper and lower sides of the grill 14 are turned on to toast the slice of toast.

After heated, the controlling circuit turns off the heaters 12 and at the same time turns on a corresponding locating member 15. Accordingly, the locating member 15 is induced to create magnetism. The locating member 15 is such arranged that when it creates magnetism, one end of the locating member 15 directed to the grill 14 has a magnetic polarity identical to the polarity of the adjacent end of the magnet 42. Therefore, after toasted, the locating member 15 will repel the grill 14 toward the open end 110 of the housing and force the grill 14 to slide to the first extending section 30 and slightly protrude from the open end 110. At this time, the user can easily take out the toasted toast and place another toast onto the grill 14. Four pairs of second stop sections 44 project from inner faces of two lateral walls of the housing 11. When the grill 14 slides outward, the second stop sections 44 stop the first stop sections 40 to prevent the grill 14 from dropping out.

By means of cooperation between the magnet 42 and the locating member 15, the grill 14 can be forcedly moved outward from the second position to the first position for easily taking out the toast. Alternatively, the grill 14 can be provided with a nonmagnetic iron plate instead of the magnet 42 or the grill 14 can be made of a material attractable by a magnet. The length of the second extending section 32 of the rail 13 is shorter than that of the first extending section 30. Therefore, when the grill 14 is no more attracted and positioned in the second position, the gravity center of the grill 14 will suspend above the first extending section 30. Under such circumstance, the grill 14 will move downward and slide outward to the first position along the declined first extending section 30.

Still alternatively, an electromagnetic valve (not shown) is provided as the locating member 15. A leaf spring of the electromagnetic valve is indirectly controlled by an induction coil. After the slice of toast is toasted, the leaf spring directly exerts a pushing force onto the grill 14 to move the grill 14 to the first position. By means of such measure, even if the length of the second extending section 32 is equal to that of the first extending section 30 or the length of the second extending section 32 is slightly longer than that of the first extending section 30, the grill 14 can be still automatically moved outward.

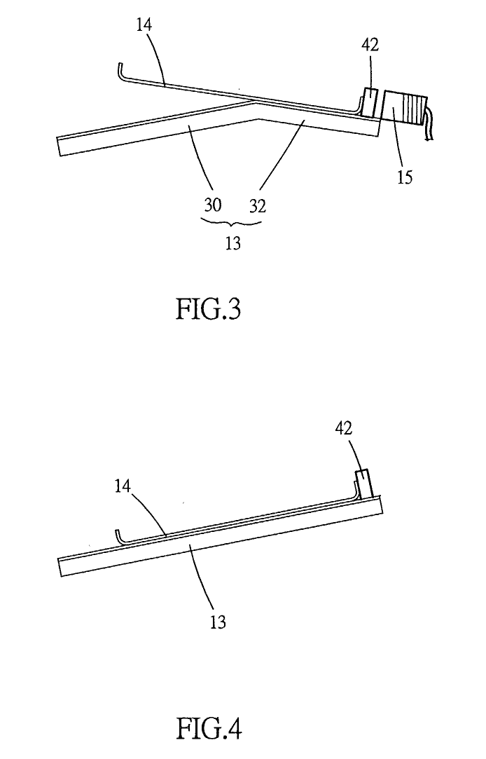

FIG. 3 shows another type of rail 13, in which the first extending section 30 inward and upward extends from the open end 110, while the second extending section 32 horizontally extends.

In FIG. 4, the first and second extending sections 30, 32 of the rail 13 of the toaster 10 extend along the same straight line. A section of the rail 13 near the open end 110 is lower. In use, the grill 14 on which a slice of toast is placed can more easily slide outward.

The above embodiments are only used to illustrate the present invention, not intended to limit the scope thereof. Many modifications of the above embodiments can be made without departing from the spirit of the present invention.

What is claimed is:

1. Vertical toaster comprising;
a housing having a front open face;
at least one pair of rails disposed in the housing, the rails being fixed on inner faces of left and right walls of the housing in parallel to each other, the rails inward extending from the front open face of the housing by a certain length;
several heaters arranged in the housing and spaced from the rails by a certain distance; and
at least one grill having a predetermined shape and bridged between the rails, the grill being reciprocally movable between a first and a second positions along a lengthwise direction, said vertical toaster being characterized in that:
a predetermined section of the rail gradually inward and upward extends; and
at least one locating member is disposed in the housing corresponding to inner side of the grill distal from the front open face of the housing, whereby a slice of toast can be horizontally placed on the grip to be heated by the heater, the locating member serving to fix the grill in the second position, after the toast is toasted, the locating member releasing the grill and making the grill slide to the first position for a user to take out the toast.

2. Vertical toaster as claimed in claim 1, wherein the rail has a first and a second extending sections respectively corresponding to the first and second positions, the heater having a predetermined length, a lengthwise direction of the heater being parallel to the second extending section.

3. Vertical toaster as claimed in claim 1, wherein the first and second extending sections of the rail extend along the same straight line.

4. Vertical toaster as claimed in claim 1, wherein the extending direction of the first extending section of the rail and the extending direction of the second extending section of the rail contain a predetermined angle.

5. Vertical toaster as claimed in claim 1, wherein a predetermined section of the grill is provided with a first stop section and a predetermined section of the housing is provided with a second stop section corresponding to the first stop section.

6. Vertical toaster as claimed in claim 1, further comprising a controlling circuit for controlling the heater and turning on/off the locating member.

7. Vertical toaster as claimed in claim 6, wherein the controlling circuit via preset wires is connected to several timers and temperature regulators the number of which is equal to the number of the grills.

8. Vertical toaster as claimed in claim 1, wherein the locating member is an electromagnetic valve.

9. Vertical toaster as claimed in claim 1, wherein a magnet is disposed on a predetermined section of the grill, the locating member being an iron core which is able to generate induced current and create magnetism, whereby when the locating member creates magnetism, one end of the locating member adjacent to the magnet has a magnetic polarity identical to the polarity of the adjacent end of the magnet.
